(19) United States
(12) Patent Application Publication
(10) Pub. No.: US 2013/0241408 A1
(43) Pub. Date: Sep. 19, 2013

(54) AUTOMOTIVE LAMP

(71) Applicant: KOITO MANUFACTURING CO., LTD., Tokyo (JP)

(72) Inventors: Yasutaka SASAKI, Shizuoka (JP); Masanobu MIZUNO, Shizuoka (JP)

(73) Assignee: Koito Manufacturing Co., Ltd., Tokyo (JP)

(21) Appl. No.: 13/874,675

(22) Filed: May 1, 2013

Related U.S. Application Data
(63) Continuation of application No. PCT/JP2011/006141, filed on Nov. 2, 2011.

(30) Foreign Application Priority Data
Nov. 11, 2010 (JP) 2010-252636

(51) Int. Cl. H05B 33/08

(52) U.S. Cl. CPC H05B 33/0854
USPC 315/50; 315/71

(57) ABSTRACT

A light-emitting module includes a light-emitting diode (LED) package, in which an LED is implemented, and a resistor, connected to the LED in series, which is placed in the position subject to a change in temperature of the LED package. The resistor has a positive temperature coefficient. The volume resistivity of the resistor at 0° C. is preferably 2×10⁻⁸ [Ω·m] or above. The temperature coefficient of the resistor in a range of 0° C. to 100° C. is preferably 0.05 [10⁻³/° C.] or above.

### CROSS-REFERENCE TO RELATED APPLICATIONS

This application is based upon and claims the benefit of priority from the prior Japanese Patent Application No. 2010-252636, filed on Nov. 11, 2010, and International Patent Application No. PCT/JP2011/006141, filed on Nov. 2, 2011, the entire content of each of which is incorporated herein by reference.

### BACKGROUND OF THE INVENTION

1. Field of the Invention

The present invention relates to an automotive lamp provided with a light-emitting module.

2. Description of the Related Art

Conventionally known is an automotive lamp utilizing a semiconductor light-emitting device such as a light emitting diode. The light-emitting diode (hereinafter referred to as “LED” as appropriate) changes its resistance value depending on the ambient temperature and therefore the voltage or current of the LED needs to be controlled when the brightness of the LED is to be kept at a constant level. In particular, there are cases where the temperature of an automotive headlamp in a lamp chamber rises greatly due to the radiation heat from an engine room of a vehicle and the like.

Proposed conventionally is an automotive lamp provided with a semiconductor light-emitting device for emitting light used for an automotive lamp and a current control unit, which supplies a preset current to the semiconductor light-emitting device and which varies the current based on the temperature of the automotive lamp (see Japanese Unexamined Patent Application Publication No. 2004-276738).

It should be noted here that an LED has generally a negative temperature coefficient in its resistance component. Accordingly, when the illumination of the LED is to be controlled by the constant voltage driving, the drive current varies significantly with a change in the temperature and therefore the brightness does not stay constant. When, on the other hand, the illumination of the LED is to be controlled by the constant current driving, a control circuit (stabilizer) comprised of an electric circuit is required and therefore the size of equipment as a whole may get larger and the cost may increase.

### SUMMARY OF THE INVENTION

The present invention has been made to solve the above-described problems, and a purpose thereof is to provide a technology by which a light-emitting module, in which the fluctuation of brightness in response to the change in temperature is significantly reduced, is realized by a simple configuration.

To resolve the foregoing problems, a light-emitting module according to one embodiment of the present invention includes: a light-emitting diode (LED) package in which an LED is implemented; and a resistor connected to the LED in series, the resistor being placed in a position subject to a change in temperature of the LED package. The resistor has a positive temperature coefficient.

### BRIEF DESCRIPTION OF THE DRAWINGS

Embodiments will now be described by way of examples only, with reference to the accompanying drawings which are meant to be exemplary, not limiting and wherein like elements are numbered alike in several Figures in which:

FIG. 1 is a graph showing a relation between ambient temperature and voltage when a commonly-used LED is driven at constant current;

FIG. 2 is a graph showing a temperature dependency of a commonly-used LED in the voltage-current characteristics thereof;

FIG. 3 is a top view schematically showing a structure of a light-emitting module according to a first embodiment of the present invention;

FIG. 4 is a graph showing an exemplary relation between ambient temperature and voltage when a light-emitting module according to a first embodiment is driven at constant current;

FIG. 5 is a graph showing a relation between the volume resistivities and the temperature coefficients of metals shown in Table 1;

FIG. 6 is a graph showing a relation among ambient temperature, voltage occurring across an LED, voltage occurring across a resistor, and the summed voltage of the voltage across the LED and the voltage across the resistor in a light-emitting module according to exemplary embodiment 1;

FIG. 7 is a graph showing a relation among ambient temperature, voltage occurring across an LED, voltage occurring across a resistor, and the summed voltage of the voltage across the LED and the voltage across the resistor in a light-emitting module according to exemplary embodiment 2;

FIG. 8 is a graph showing a relation among ambient temperature, voltage occurring across an LED, voltage occurring across a resistor, and the summed voltage of the voltage across the LED and the voltage across the resistor in a light-emitting module according to exemplary embodiment 3;

FIG. 9 is a graph showing a relation among ambient temperature, voltage occurring across an LED, voltage occurring across a resistor, and the summed voltage of the voltage across the LED and the voltage across the resistor in a light-emitting module according to exemplary embodiment 4;

FIG. 10 is a graph showing a relation between ambient temperature and current value when a light-emitting module having a resistor, formed of stainless material, according to exemplary embodiment 3 is driven at constant voltage and when a light-emitting module without such a resistor is driven at constant voltage, respectively;

FIG. 11 is a perspective view schematically showing a structure of a light-emitting module according to a modification of a first embodiment;

FIG. 12 is a graph showing a temperature dependency of current value when an LED is driven at constant voltage;

FIG. 13 is a graph showing a case where FIG. 12 is normalized with the current value at −20° C. being 100%;

FIG. 14 is a graph to explain the voltage-current (V-I) characteristics of a light-emitting module according to a second embodiment of the present invention;

FIG. 15 is a schematic cross-sectional view of an automotive lamp according to a third embodiment of the present invention;

FIG. 16 is a schematic cross-sectional view of an automotive lamp according to a fourth embodiment of the present invention;

FIG. 17 is a schematic cross-sectional view of an automotive lamp according to a fifth embodiment of the present invention; and

FIG. 18 is a top view schematically showing a structure of a light-emitting module according to a sixth embodiment of the present invention.

### DETAILED DESCRIPTION OF THE INVENTION

A light-emitting module according to one embodiment of the present invention includes a light-emitting diode (LED) package in which an LED is implemented and a resistor, connected to the LED in series, which is placed in a position subject to a change in temperature of the LED package. The resistor has a positive temperature coefficient.

By employing this embodiment, even though the resistance of the LED decreases (increases), the resistance of a resistor placed in a position subject to a change in temperature of the LED package increases (decreases). As a result, the change in resistance of the light-emitting module as a whole can be mitigated. Thus, the temperature dependence of the current flowing through the LED can be made smaller even if the light-emitting module is driven at constant voltage.

The volume resistivity of the resistor at 0° C. may be 2×10⁻⁸ [Ω·m] or above.

The temperature coefficient of the resistor in a range of 0° C. to 100° C. may be 0.05[10⁻³/° C.] or above. In some cases, a resistor constituting a circuitry has a positive temperature coefficient and its value is very small. It is avoided to use a resistor, having a large positive temperature coefficient, in the circuitry. A resistor, which has a positive temperature large enough so that the use of such a resistor for the circuitry is generally avoided, and an LED generally having a negative temperature coefficient in its resistance component are combined. Thereby, the change in resistance of the LED package resulting from temperature changes can be further mitigated.

Note that a single resistor or a plurality of resistors may be provided as the resistor(s), having a positive temperature coefficient, which is/are included in the light-emitting module. If a plurality of resistors are used in combination, the same type of resistors may be combined or those of different types may be combined.

When the total electric power applied to all of LED chips in the light-emitting module is J [watt (W)], the total electric power applied to all of the resistors in the light-emitting module may be 0.2×J [W] or above.

Another embodiment of the present invention relates also to an automotive lamp. This automotive lamp is used for a vehicle and it includes the aforementioned light-emitting module; an optical element for irradiating light emitted by the light-emitting module toward a front area of the vehicle; and a lamp housing that houses the light-emitting module and the optical element. The LED package and the resistor are placed in regions inside the lamp housing under an identical atmosphere.

By employing this embodiment, an automotive lamp whose variation in brightness and luminance relative to the changes in temperature is reduced can be realized.

The automotive lamp may further include a heat-radiating member that supports the LED package and radiates heat generated by the LED package. The resistor may be mounted on the heat-radiating member. Thereby, the variation in temperatures of the LED package and the resistor is inhibited, so that an automotive lamp, whose variation in brightness is further reduced in the event that the ambient temperature changes, can be realized.

Still another embodiment of the present invention relates to an automotive lamp. This automotive lamp is used for a vehicle and it includes: a light-emitting module; an optical element for irradiating light emitted by the light-emitting module toward a front area of the vehicle; a lamp housing that houses the light-emitting module and the optical element; and a heat-radiating member that supports the LED package and radiates heat generated by the LED package to the exterior of the lamp housing. The resistor is mounted in a region, which is exposed outside the lamp housing, in the heat-radiating member.

By employing this embodiment, the variation in temperatures of the LED package and the resistor is further inhibited, so that an automotive lamp, whose variation in brightness is further reduced in the event that the ambient temperature changes, can be realized.

Optional combinations of the aforementioned constituting elements, and implementations of the invention in the form of methods, apparatuses, systems, and so forth may also be practiced as additional modes of the present invention.

The invention will now be described by reference to the preferred embodiments. This does not intend to limit the scope of the present invention, but to exemplify the invention.

The preferred embodiments for carrying out the present invention will now be hereinbelow described in detail with reference to the accompanying drawing. Note that the identical components are given the identical reference numerals in all accompanying figures and that the repeated description thereof will be omitted as appropriate.

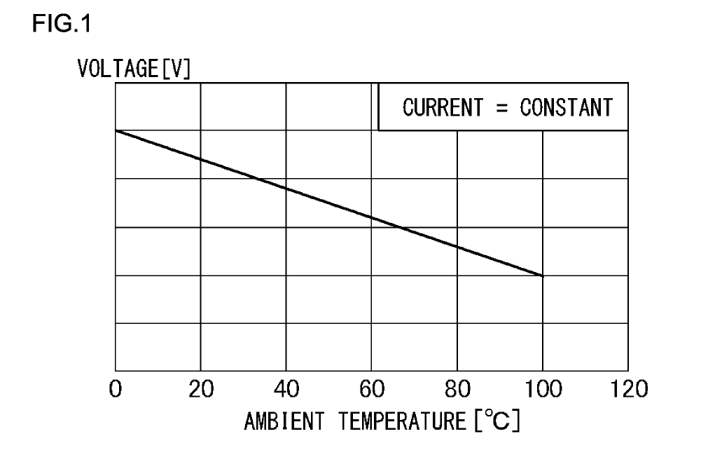

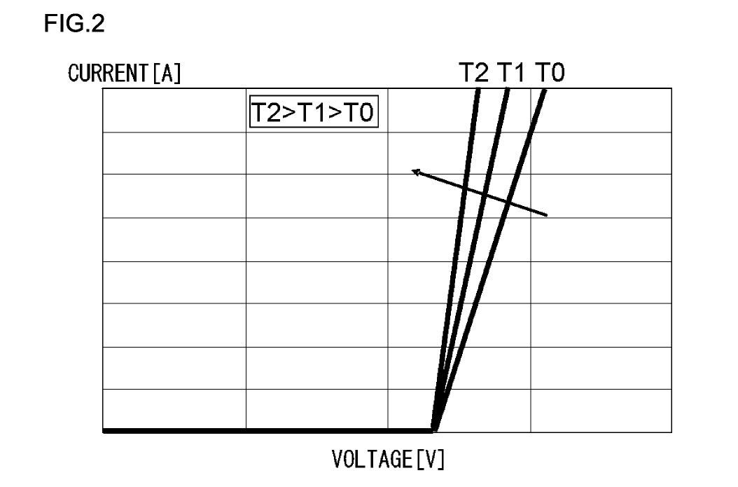

In general, an LED has a negative temperature coefficient in its resistance component. FIG. 1 is a graph showing a relation between ambient temperature and voltage when a commonly-used LED is driven at constant current. As shown in FIG. 1, the drive voltage of LED drops as the ambient temperature rises. FIG. 2 is a graph showing a temperature dependency of a commonly-used LED in the voltage-current characteristics thereof. As shown in FIG. 2, the change in current relative to the change in voltage becomes larger as the ambient temperature rises (T2>T1>T0). As observed through these characteristics, a stabilizer such as a control circuit is additionally required if a commonly-used LED is to be driven at constant current.

In other words, such a control circuit can be simplified or omitted if the temperature dependence of current is low when the LED is driven at constant current. In the light of this, the inventors of the present invention have come to recognize that a light-emitting module, whose variation in brightness is small relative to the change in temperature, can be realized by a simple configuration if a resistor having a positive temperature coefficient is generally connected in series with an LED having a negative temperature coefficient in a resistance component of the LED.

### First Embodiment

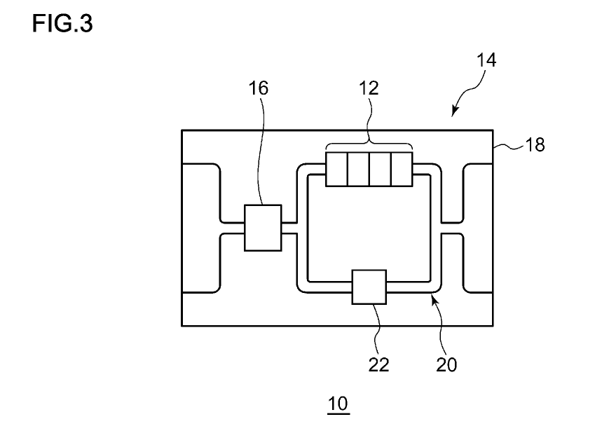

FIG. 3 is a top view schematically showing a structure of a light-emitting module 10 according to a first embodiment. The light emitting module 10 includes an LED package 14, in which an LED 12 is implemented, and a resistor 16. The LED 12 according to the first embodiment contains a plurality of chips. The LED package 14 includes a thermally conductive insulating substrate 18, which is formed of a ceramic or the like, a wiring pattern 20 formed on the thermally conductive insulating substrate 18, and a zener diode 22.

The resistor 16 is connected in series with the LED 12. Also, the resistor 16 is flip-chip mounted on the wiring pattern 20 of the LED package 14. Accordingly, the resistor 16 is placed in a position subject to a change in temperature of the LED package 14. The zener diode 22, which is placed in parallel with the LED 12, functions as a protection element that protects the LED 12 against an excessive voltage. The resistor 16 according to the first embodiment has a positive temperature coefficient. The LED chip may be a vertical (VC) chip.

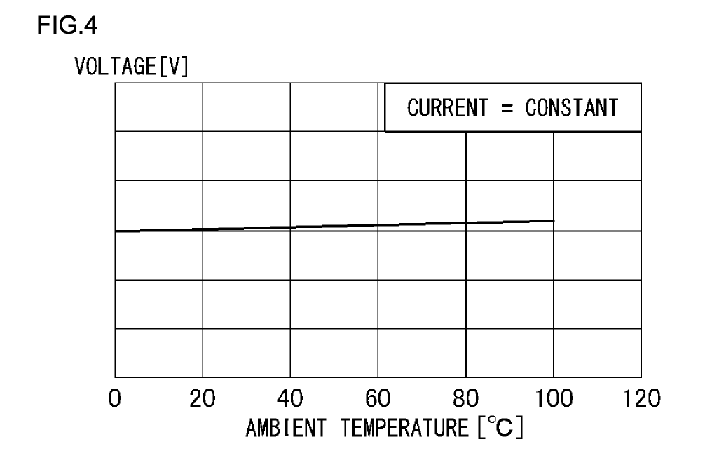

FIG. 4 is a graph showing an exemplary relation between ambient temperature and voltage when a light-emitting module according to the first embodiment is driven at constant current. Even though the resistance of the LED 12 decreases (increases), the resistance of the resistor 16 placed in a position subject to a change in temperature of the LED 12 increases (decreases) in the light-emitting module 10 according to the first embodiment. Thus, the change in resistance of the light-emitting module as a whole can be mitigated if the material and the structure used for the resistor are selected and designed appropriately according to the LED used.

As shown in FIG. 4, therefore, the light-emitting module according to the first embodiment has a smaller temperature dependence of voltage as compared with the light-emitting module having the LED only. In other words, the temperature dependence of the current flowing through the LED can be made smaller even if the light-emitting module according to the first embodiment is driven at constant voltage. That is, a light-emitting module, whose variation in brightness relative to the changes in temperature is smaller can be realized using a simplified control unit or without using a control circuit.

Since the life of the control circuit is normally shorter than that of the LED chips, the life of the light-emitting module as a whole is dependent on the life of the control circuit. If, however, the light-emitting module can be configured without using the control circuit, the life of the light-emitting module and the life of a lamp comprised of the light-emitting module can be prolonged up to the uninterrupted life of the LED chips.

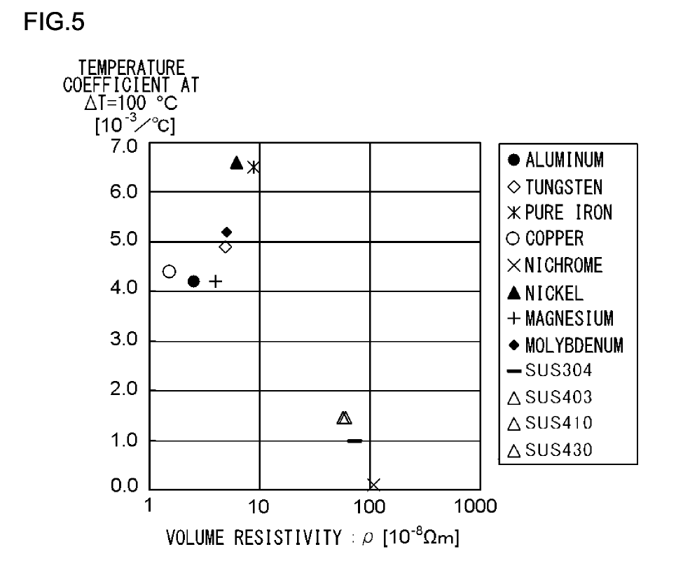

Table 1 shows, by an example, volume resistivities ρ and temperature coefficients α of metals each having a positive temperature coefficient. FIG. 5 is a graph showing a relation between the volume resistivities and the temperature coefficients of metals shown in Table 1. Note that, in Table 1, the resistivity of each metal is a value at 0° C., and the temperature coefficient thereof is a value in a range of 0° C. to 100° C. (ΔT=100° C.)

TABLE 1

| | Volume | Temperature |
|---|---|---|
| | resistivity ρ | coefficients α |
| | [10⁻⁸ Ωm] | [10⁻³/° C.] |
| Aluminum | 2.5 | 4.2 |
| Tungsten | 4.9 | 4.9 |
| Pure iron | 8.9 | 6.5 |
| Copper | 1.55 | 4.4 |
| Nichrome | 107.3 | 0.1 |
| Nickel | 6.2 | 6.6 |
| Magnesium | 3.94 | 4.2 |
| Molybdenum | 5 | 5.2 |
| SUS304 | 72 | 1.0 |
| SUS403 | 57 | 1.5 |
| SUS410 | 57 | 1.5 |
| SUS430 | 60 | 1.5 |

The volume resistivity of the resistor 16, at 0° C., according to the first embodiment is preferably 2×10⁻⁸ [Ω·m] or above. More preferably, the volume resistivity thereof at 0° C. is 3×10⁻⁸ [Ω·m] or above.

Also, the temperature coefficient of the resistor 16, in a range of 0° C. to 100° C., according to the first embodiment has preferably a positive temperature coefficient. More preferably, the temperature coefficient thereof in a range of 0° C. to 100° C. is 0.05[10⁻³/° C.] or above. Thereby, the change in resistance of the LED package 14 resulting from temperature changes can be further mitigated. A detailed description is given hereunder of relations among the ambient temperature, the voltage occurring across the LED 12 and the voltage occurring across the resistor 16 in a light-emitting module configured by various types of LED packages.

### Exemplary Embodiment 1

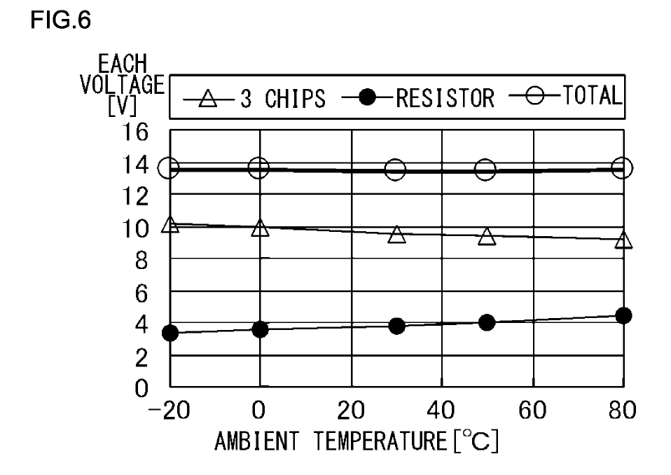

FIG. 6 is a graph showing a relation among the ambient temperature, the voltage occurring across an LED, the voltage occurring across a resistor, and the summed voltage of the voltage across the LED and the voltage across the resistor in a light-emitting module according to exemplary embodiment 1. A resistor, formed mainly of aluminum, having a resistance of 5.4Ω is connected in series with an LED composed of three LED chips, and a current of 0.7 A is delivered at the ambient temperature of 25° C. in the light-emitting module according to exemplary embodiment 1. Where the current is supplied at a constant level as described above, the voltages occurring across the resistor formed mainly of aluminum are 3.36 V and 4.41 V at −20° C. and 80° C., respectively, and the voltage difference in this case is about 1.04 V. The voltages across the LED composed of three LED chips are 10.13 V and 9.14 V at −20° C. and 80° C., respectively, and the voltage difference in this case is about −0.98 V. The summed voltage of the voltage across the resistor and the voltage across the LED are 13.49 V and 13.55 V at −20° C. and 80° C., respectively, and the voltage difference in this case is 0.06 V.

### Exemplary Embodiment 2

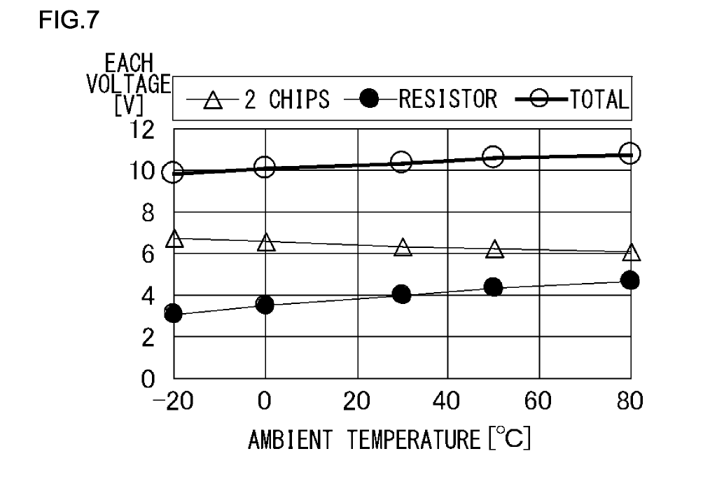

FIG. 7 is a graph showing a relation among the ambient temperature, the voltage occurring across an LED, the voltage occurring across a resistor, and the summed voltage of the voltage across the LED and the voltage across the resistor in a light-emitting module according to exemplary embodiment 2. A resistor, formed mainly of tungsten, having a resistance of 5.7Ω is connected in series with an LED composed of two LED chips, and a current of 0.7 A is delivered at the ambient temperature of 25° C. in the light-emitting module according to exemplary embodiment 2. Where the current is supplied at a constant level as described above, the voltages occurring across the resistor formed mainly of tungsten are 3.11 V and 4.67 V at −20° C. and 80° C., respectively, and the voltage difference in this case is 1.56 V. The voltages across the LED composed of two LED chips are 6.75 V and 6.09 V at −20° C. and 80° C., respectively, and the voltage difference in this case is −0.66 V. The summed voltage of the voltage across the resistor and the voltage across the LED are 9.86 V and 10.76 V at −20° C. and 80° C., respectively, and the voltage difference in this case is 0.90 V.

### Exemplary Embodiment 3

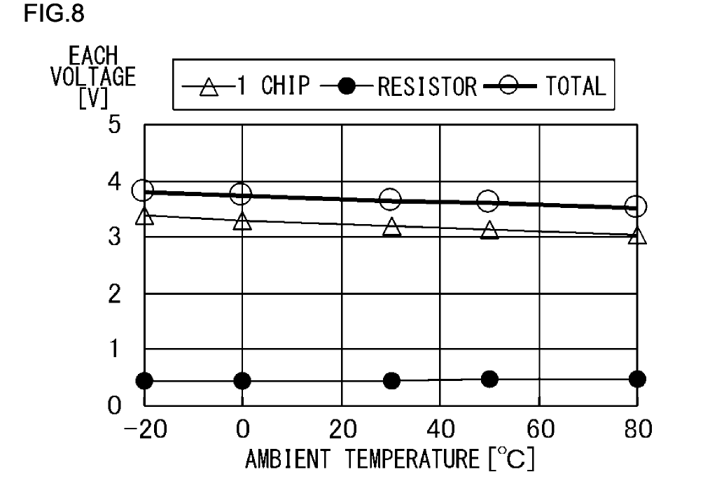

FIG. 8 is a graph showing a relation among the ambient temperature, the voltage occurring across an LED, the voltage occurring across a resistor, and the summed voltage of the voltage across the LED and the voltage across the resistor in a light-emitting module according to exemplary embodiment 3. A resistor, formed mainly of a stainless material, having a resistance of 0.64Ω is connected in series with an LED composed of one LED chip, and a current of 0.7 A is delivered at the ambient temperature of 25° C. in the light-emitting module according to exemplary embodiment 3. Where the current is supplied at a constant level as described above, the voltages occurring across the resistor formed mainly of the stainless material are 0.43 V and 0.47 V at −20° C. and 80° C., respectively, and the voltage difference in this case is 0.04 V. The voltages across the LED composed of one LED chip are 3.38 V and 3.05 V at −20° C. and 80° C., respectively, and the voltage difference in this case is −0.33 V. The summed voltage of the voltage across the resistor and the voltage across the LED are 3.81 V and 3.52 V at −20° C. and 80° C., respectively, and the voltage difference in this case is 0.29 V.

### Exemplary Embodiment 4

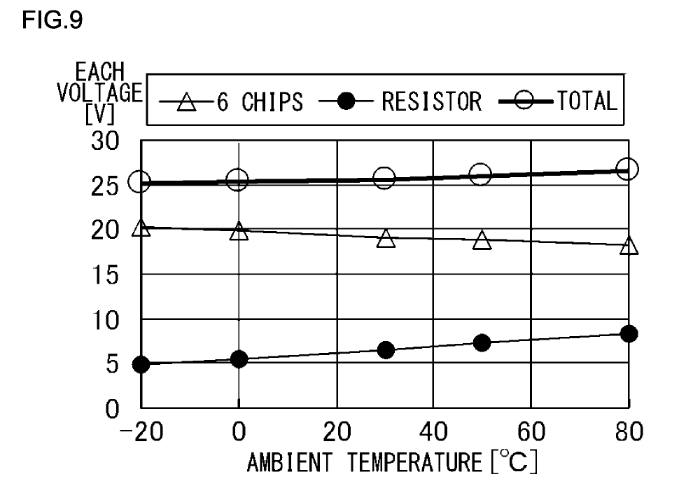

FIG. 9 is a graph showing a relation among the ambient temperature, the voltage occurring across an LED, the voltage occurring across a resistor, and the summed voltage of the voltage across the LED and the voltage across the resistor in a light-emitting module according to exemplary embodiment 4. A resistor, formed mainly of nickel, having a resistance of 9.29Ω is connected in series with an LED composed of six LED chips, and a current of 0.7 A is delivered at the ambient temperature of 25° C. in the light-emitting module according to exemplary embodiment 4. Where the current is supplied at a constant level as described above, the voltages occurring across the resistor formed mainly of nickel are 4.93V and 8.38 V at −20° C. and 80° C., respectively, and the voltage difference in this case is 3.45 V. The voltages across the LED composed of six LED chips are 20.25 V and 18.28 V at −20° C. and 80° C., respectively, and the voltage difference in this case is −1.97 V. The summed voltage of the voltage across the resistor and the voltage across the LED are 25.18 V and 26.66 V at −20° C. and 80° C., respectively, and the voltage difference in this case is 1.48 V.

As shown in exemplary embodiment 1 to exemplary embodiment 4, the resistor having a positive temperature coefficient is connected in series with the LED. Thereby, the variation in voltage relative to the change in ambient temperature is inhibited as compared with the case where the LED only is provided. For example, the variation in voltage relative to the change in ambient temperature in the range of the change being ΔT=100° C. is very small. Accordingly, even though the light-emitting module according to exemplary embodiment 1 is driven at constant voltage without the control circuit, the variation in brightness relative to the change in ambient temperature is small.

In particular, the light-emitting module according to the first embodiment is preferably configured such that when a constant voltage is delivered in the range of −20° C. and 80° C., namely ΔT=100° C., the maximum voltage difference that occurs across the resistor and the LED is in the range of −0.3 V and 1.5 V. Thereby, the light-emitting module can be directly driven at constant voltage by the battery of an automobile.

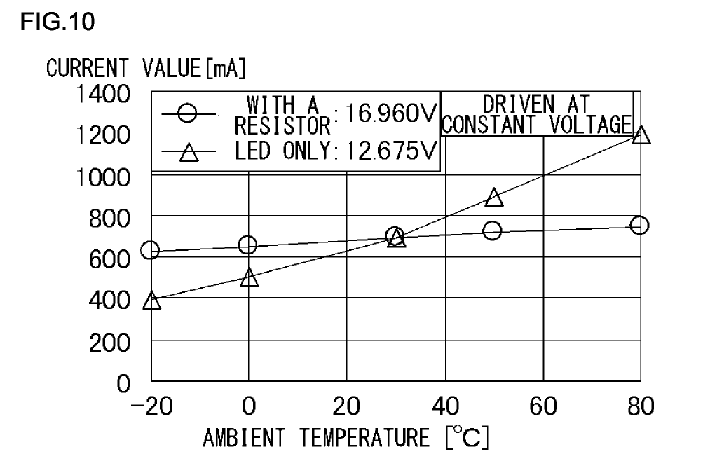

FIG. 10 is a graph showing a relation between the ambient temperature and the current value when a light-emitting module having a resistor, formed of stainless material, according to exemplary embodiment 3 is driven at constant voltage and when a light-emitting module without such a resistor is driven at constant voltage, respectively. As evident from FIG. 10, the minimum value of current and the maximum value of current, when the light-emitting module having an LED only is driven at constant voltage, are 393 mA and 1190 mA, respectively, and therefore the difference between the minimum value thereof and the maximum value thereof is 797 mA. On the other hand, the minimum value of current and the maximum value of current, when the light-emitting module having the resistor is driven at constant voltage, are 628 mA and 746 mA, respectively, and therefore the difference therebetween is 118 mA. This shows that the light-emitting module, in which the resistor is connected in series with the LED, significantly reduces the change in current occurring when the light-module is driven at constant voltage.

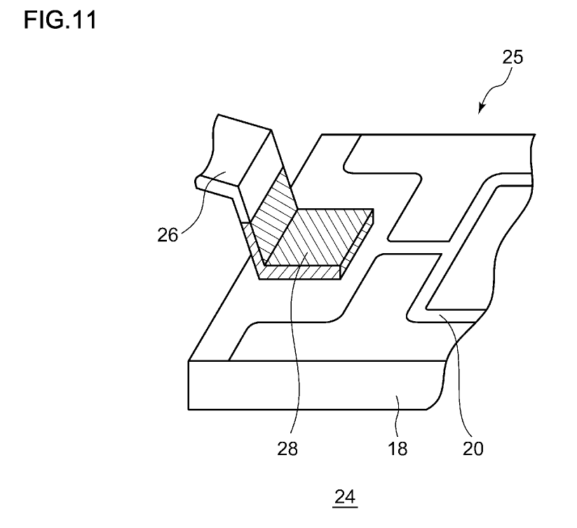

FIG. 11 is a perspective view schematically showing a structure of a light-emitting module according to a modification of the first embodiment. A light-emitting module 24 shown in FIG. 11 is configured such that a resistor 28 is built into a power-feeding terminal 26 used to enable the power feeding to an LED package 25 from the outside. Though the light-emitting module 24 is configured as shown in FIG. 11, the resistor 28 is positioned on the LED package 25 and therefore tends to follow the temperature of the LED. Also, provision of the resistor in the power-feeding terminal enables the resistor to be combined with various types of LED packages.

### Second Embodiment

A description is hereinbelow given of the dependence of the ambient temperature on the current flowing through the LED when light-emitting modules, where their resistors are formed of wire (steel), SUS304, and nichrome wire, respectively, are driven at constant voltage. Note that the LED used in a second embodiment has a luminance efficiency of approximately 50 lm/W and is connected in series with the resistors using the aforementioned materials.

The temperature characteristics of current flowing through the LED are measured using a thermal resistance test. The ambient temperatures for the measurements are −20° C., 30° C. and 80° C. The voltage applied at each measurement is 13.2 V and the voltage is applied for 15 minutes at each measurement. Also, the materials used for the resistor are as follows (see Table 2).

TABLE 2

| Material | Wire | SUS304 | Nichrome wire |
|---|---|---|---|
| Wire diameter | φ0.28 mm | φ0.30 mm | φ0.30 mm |

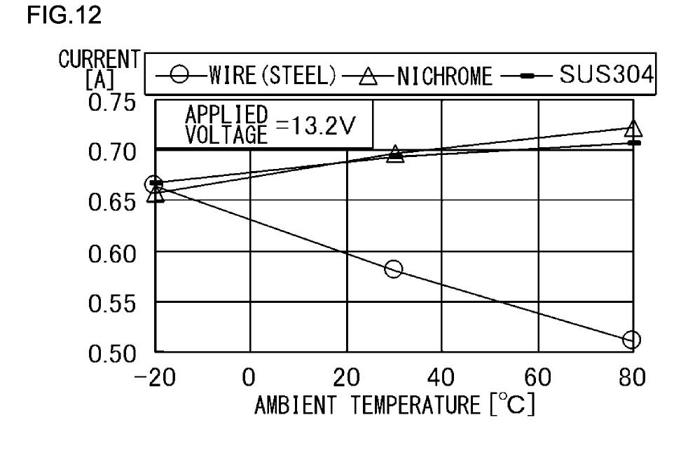

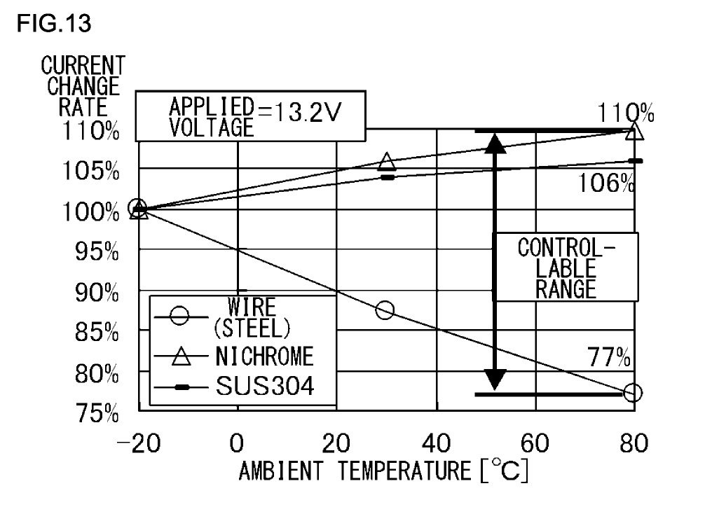

FIG. 12 is a graph showing a temperature dependency of current value when an LED is driven at constant voltage of 13.2 V. FIG. 13 is a graph showing a case where FIG. 12 is normalized with the current value at −20° C. being set to 100%. For the resistor formed of wire (steel), the current flowing through the LED is the forward current If of 0.66 A at −20° C. and the forward current If of 0.51 A at 80° C., so that as the temperature rises by 100° C., the current is reduced by about 23%. For the resistor formed of SUS304, the current flowing through the LED is the forward current If of 0.67 A at −20° C. and the forward current If of 0.71 A at 80° C., so that as the temperature rises by 100° C., the current is reduced by about 6%. For the resistor formed of nichrome wire, the current flowing through the LED is the forward current If of 0.66 A at −20° C. and the forward current If of 0.72 A at 80° C., so that as the temperature rises by 100° C., the current increases by about 10%.

As evident from the above results, when the current value at −20° C. in each light-emitting module is set to 100%, the current at 80° C. can be controlled between an increase by 10% and a decrease by 23% if the wire, SUS304, and the nichrome wire are used in combination, as appropriate, as the resistor. This means that when the light-emitting module is driven at constant voltage, the variation in current at the ambient temperature of −20° C. to 80° C. can be suppressed to an almost constant level in theory (within ±1%).

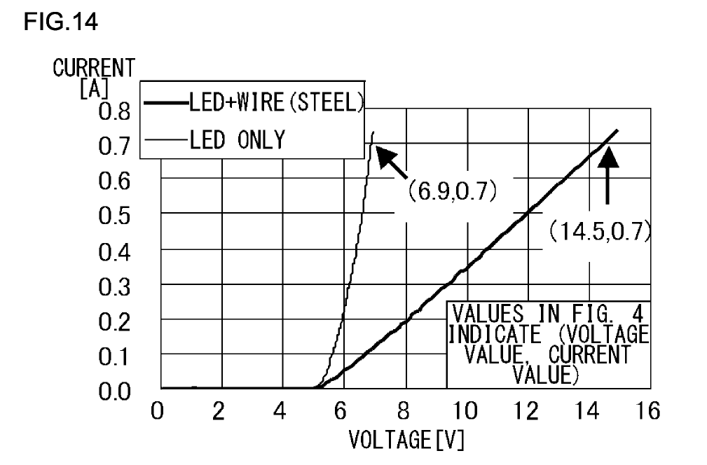

A description is now given of the luminance efficiency when the resistor is connected in series with the LED. FIG. 14 is a graph to explain the voltage-current (V-I) characteristics of a light-emitting module according to the second embodiment. As evident from FIG. 14, the power of the LED only is 4.83 W (0.7 A×6.9 V). On the other hand, the power, when the wire (steel) is connected to this LED in series, is 10.15 W (0.7 A×14.5 V). Suppose that the luminance efficiency of the LED used is 50 lm/W, then the luminous flux obtained will be 241 lm (50 lm/W×4.83 W). Suppose also that the same luminous flux as the above is obtained by a light-emitting module where the LED and the wire (steel) are connected in series with each other, then the luminance efficiency will be 241 [lm]/10.15 [W]≈24 [lm/W]. As evident from above, the luminance efficiency is lowered but the luminous flux and the luminance are remained the same irrespective of whether the resistor is provided or not.

The size of the LED according to the second embodiment is 1×1 mm. The number of LED chips used in the second embodiment is two. If the luminous flux becomes insufficient in the light-emitting module where two LED chips and the resistor are connected in series with each other, the unit of LED chips and the register connected in series may be provided in plurality so that a plurality of such units are connected in parallel with each other unit. The light-emitting module configured by a plurality of such units connected in parallel exhibits the luminance efficiency of about 24 lm/W, and the luminous flux of this light-emitting module can be made larger by a factor of the number of a plurality of such units.

### Third Embodiment

A description is given hereunder of an automotive lamps employing the above-described light-emitting modules. The automotive lamps using the above-described light-emitting modules are preferably a headlamp (HL) and a day running lamp (DRL), for instance. In HL and DRL, which are installed near an engine, the variation in the ambient temperature of HL and DRL is greater than that of a rear combination lamp (RCL), and HL and DRL are therefore subject to the effect of the heat in the lamp unit. Accordingly, the above-described light-emitting modules, whose variations in brightness relative to the changes in ambient temperature are smaller, are used in HL and DRL as the light sources, so that the illumination performance more stable than that of the conventional HL and DRL can be realized with a simple configuration.

Also, a white-color LED is generally used for the light-emitting module used in HL, and a white-color, blue-color or green-color LED is generally used for the light-emitting module in DRL. And a large electric power (e.g., 10 W or more) is applied per lamp for the lighting. On the other hand, a red-color LED is generally used for the light-emitting module in RCL and a relatively small power (e.g., about 5 W) is applied for illumination. Also, HL and DRL are normally used for many hours of continuous lighting. On the other hand, RCL is normally used for an instantaneously short time.

Thus, the amount of heat produced by HL and DRL at their light sources is larger than that by RCL and therefore the temperature of HL and DRL is more likely to rise than that of RCL. Thus, the above-described light-emitting modules, whose variations in brightness relative to the changes in ambient temperature are smaller, are used as the light sources, so that the illumination performance more stable than that of the conventional HL and DRL can be realized with a simple configuration.

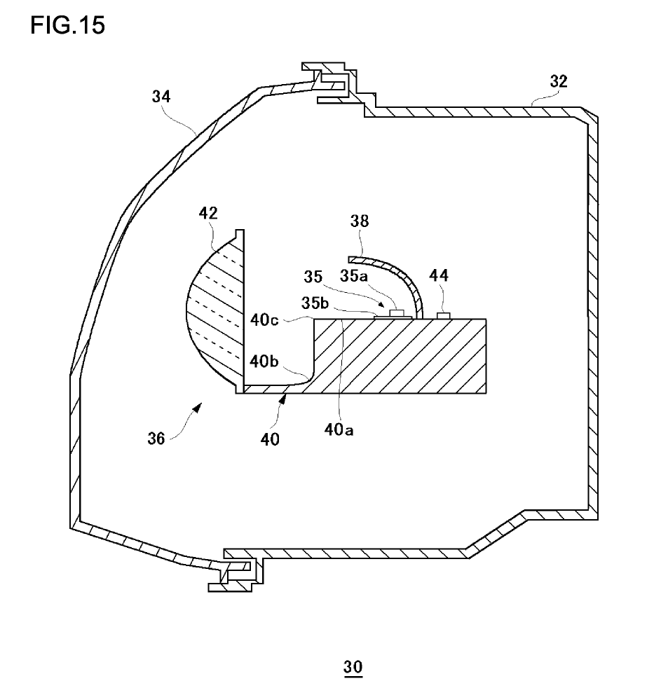

In each of the following embodiments, a description will be given of cases where, for example, HL is used as the automotive lamp using the light-emitting modules according to the above-described embodiments. FIG. 15 is a schematic cross-sectional view of an automotive lamp 30 according to a third embodiment of the present invention. The automotive lamp 30 according to the third embodiment is configured such that a lamp unit 36, which includes an LED package 35 as the light source, is housed in a lamp chamber formed by a lamp body 32 and an outer lens 34 fitted in the front end opening of the lamp body 32. Also, the lamp unit 36 is fixed within the lamp chamber by a not-shown bracket and the like.

The lamp unit 36, which is a reflective projector-type lamp unit, includes an LED package 35 and a reflector 38 that reflects light emitted from the LED package 35 in the frontward direction of the vehicle. Also, the lamp unit 36 includes a shade 40 fixed to the bracket and a projection lens 42 held by the shade.

The LED package 35 comprises, for example, an LED 35a composed of LED chips and a thermally conductive insulating substrate 35b formed of a ceramic or the like. The LED 35a is disposed on the thermally conductive insulating substrate 35b. The LED package 35 is placed on the shade 40 such that the illumination axis of the LED package 35 faces upward along an approximately vertical direction which is approximately vertical to an irradiation direction (leftward in FIG. 15) of the lamp unit 36. Note the illumination axis of the LED package 35 is adjustable according to the shape thereof and the light distribution in the forward direction thereof. Also, the LED package 35 may be structured such that a plurality of LEDs 35a are provided.

In addition to the LED package 35, a resistor 44 is mounted on the shade 40. The resistor 44 is connected in series with the LED 35a of the LED package 35 by use of a not-shown wiring. As described in each of the above-described embodiments, the resistor 44 has a positive temperature coefficient. In the third embodiment, the LED package 35 and the resistor 44 constitute a light-emitting module.

The reflector 38 is a reflector member formed such that a reflective surface thereof, which is constituted by a part of an ellipsoid of revolution, for instance, is formed inside the reflector 38 and one end thereof is fixed to the shade 40. The shade 40 includes a planar part 40a and a bent part 40b. The planar part 40a is disposed approximately horizontally. The area in front of this planar part 40a is bent downward in a recessed manner and is structured as the bent part 40b. And the bent part 40b occupying the front part of the shade 40 is structured so that light irradiated from the LED package 35 is not reflected. The reflector 38 is designed and arranged such that the first focal point thereof is positioned near the LED package 35 and such that the second focal point thereof is positioned near a ridge line 40c formed by the planar part 40a and the bent part 40b in the shade 40.

The projection lens 42 is a plano-convex aspheric lens, having a convex front surface and a plane rear surface, which projects the light reflected by the reflective surface of the reflector 38 toward a front area of the lamp. The projection lens 42 is disposed on a light axis extending in frontward and rearward directions of the vehicle, and is fixed to the tip end of the shade 40 in a front side of the vehicle. A rear focal point of the projection lens 42 is configured, for instance, such that the rear focal point thereof approximately matches the second focal point of the reflector 38. Also, the projection lens 42 is configured such that an image on a rear focal point face containing the rear focal point is projected onto a vertical virtual screen disposed in front of the lamp, as a reverted image.

The light emitted from the LED 35a of the LED package 35 is reflected by the reflective surface of the reflector 38 and enters the projection lens 42 after passing through the second focal point. The light having entered the projection lens 42 is collected by the projection lens 42 so as to be irradiated frontward as approximately parallel light beams. Also, part of light beams are reflected by the planar part 40a with the ridge line 40c of the shade 40 as a boundary, so that the light beams are selectively cut and therefore a diagonal cut-off line is formed in a light distribution pattern projected onto a front part of the vehicle.

As described above, the automotive lamp 30 includes the LED package 35, the reflector 38 and the projection lens 42, which irradiate the light emitted from the LED package 35 toward a front area of the vehicle, and the lamp body 32 that houses the lamp unit 36. Also, the LED package 35 and the resistor 44 are installed in the lamp chamber inside the lamp housing formed by the lamp body 32, the outer lens 34 and the like, so that the LED package 35 and the resistor 44 are placed in regions inside the lamp housing under an identical atmosphere, respectively.

The shade 40 according to the third embodiment not only supports the LED package 35 but also functions as a heat-radiating member that radiates and dissipate the heat of the LED package 35. Similar to the LED package 35 placed on the shade 40, the resistor 44 is also mounted on the shade 40. As a result, the variation in temperatures of the LED package 35 and the resistor 44 is suppressed and therefore an automotive lamp, whose variation in brightness is further reduced in the event that the ambient temperature changes, can be realized.

Also, the light-emitting module according to the third embodiment is configured such that the LED 35a, having a negative temperature coefficient, and the resistor 44, having a positive temperature coefficient, are connected in series with each other. Thus, the variation in resistance relative to the temperature is suppressed. Hence, even though the light-emitting module is driven at constant voltage, an automotive lamp whose variation in brightness and luminance is small can be realized. Also, since the light-emitting module can be driven at constant voltage, a vehicle's battery can be used as the power source of the light-emitting module.

### Fourth Embodiment

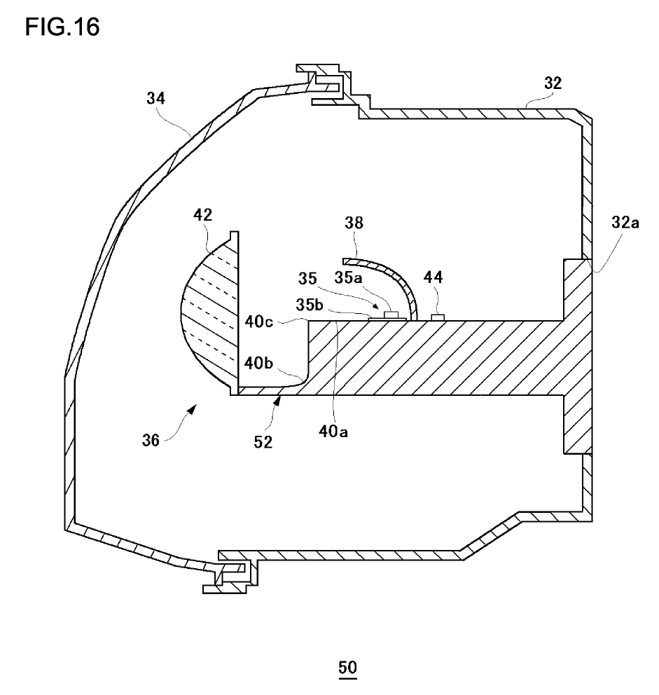

FIG. 16 is a schematic cross-sectional view of an automotive lamp 50 according to a fourth embodiment of the present invention. In the following description, the identical components to those of the third embodiment are given the identical reference numerals, and the repeated description thereof will be omitted. The automotive lamp 50 according to the fourth embodiment is similar to the automotive lamp according to the third embodiment excepting that the shape of the shade, which functions as the heat-radiating member as well, differs.

In the automotive lamp 50 according to the fourth embodiment, a rear end of a shade 52 (toward the rear end of the vehicle) is exposed from an opening 32a formed in the lamp body 32. Thus, the heat produced at the LED package 35 and the resistor 44 can be efficiently released to the exterior of the automotive lamp 50. Thereby, the variation in temperatures of the LED package 35 and the resistor 44 is further suppressed and therefore an automotive lamp, whose variation in brightness is further reduced, can be realized.

### Fifth Embodiment

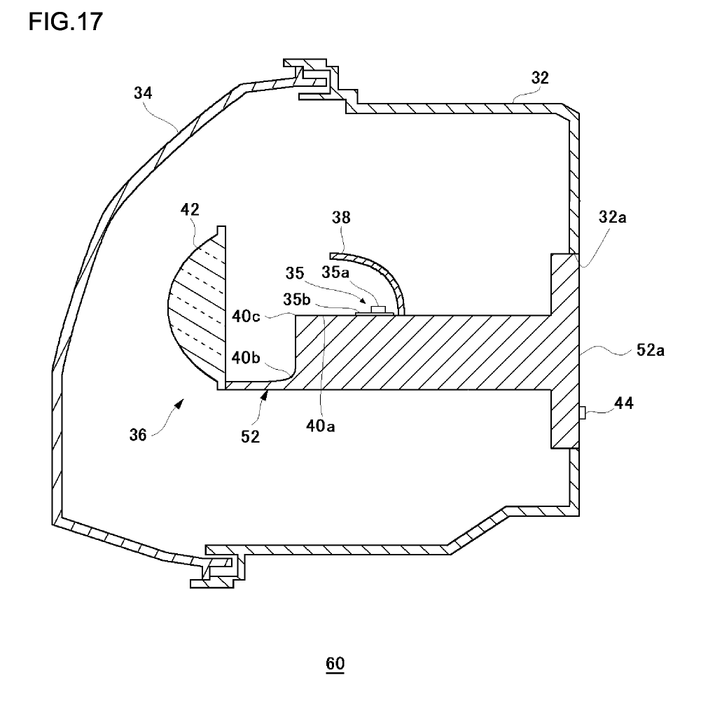

FIG. 17 is a schematic cross-sectional view of an automotive lamp 60 according to a fifth embodiment of the present invention. In the following description, the identical components to those of the fourth embodiment are given the identical reference numerals, and the repeated description thereof will be omitted. The automotive lamp 60 according to the fifth embodiment is similar to the automotive lamp according to the fourth embodiment excepting that the resistor is placed outside the lamp chamber in this fifth embodiment.

In the automotive lamp 60 according to the fourth embodiment, the rear end of the shade 52 (toward the rear end of the vehicle) is exposed from the opening 32a formed in the lamp body 32. Also, the resistor 44 is mounted in an exposed section 52a of the shade 52. Thus, the heat produced at the LED package 35 and the resistor 44 can be efficiently released to the exterior of the automotive lamp 60. Thereby, the variation in temperatures of the LED package 35 and the resistor 44 is further suppressed and therefore an automotive lamp, whose variation in brightness is further reduced, can be realized.

### Sixth Embodiment

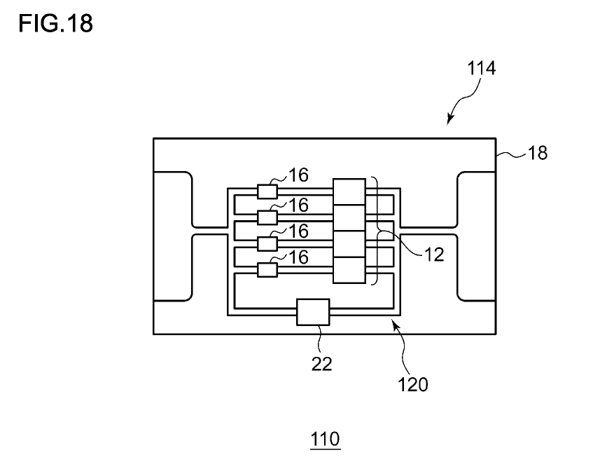

FIG. 18 is a top view schematically showing a structure of a light-emitting module 110 according to a sixth embodiment of the present invention. The light-emitting module 110 includes an LED package 114, in which an LED 12 is implemented, and four resistors 16. The LED 12 according to the sixth embodiment contains four chips, and these four chips are electrically connected in parallel with each other. The LED package 114 includes a thermally conductive insulating substrate 18, which is formed of a ceramic or the like, a wiring pattern 120 formed on the thermally conductive insulating substrate 18, and a zener diode 22.

Each resistor 16 is connected to each chip of the LED 12 in series. That is, the LED package 114 according to the sixth embodiment is a parallel circuit configured such that four units, each of which is comprised of a single LED chip and a single resistor connected in series with each other, are connected in parallel with each other. Also, each resistor 16 is flip-chip mounted on the wiring pattern 120 of the LED package 114. Accordingly, each resistor 16 is placed in a position subject to a change in temperature of the LED package 114. The zener diode 22, which is placed in parallel with the LED 12, functions as a protection element that protects the LED 12 against an excessive voltage.

A description is now given of advantageous effects achieved by the LED package 114 including a parallel circuit where a plurality of units, each of which is comprised of a single LED chip and a single resistor connected in series with each other, are connected in parallel with each other.

Where a plurality of LED chips, which are four LED chips, for instance, are connected in series with each other, a voltage of about 13 V is required to illuminate the LED. At the same time, the voltage of the vehicle's battery is normally about 13.5 V and thus it is possible for the vehicle's battery to illuminate the LED if the voltage is stable. However, the voltage of the battery varies in a range of about 10 to about 16 V due to various factors. Accordingly, the LED cannot be lit up if the battery voltage falls below 13 V. Further, in consideration of a voltage drop at the resistors connected in series with the LED chips, respectively, it is difficult to ensure the voltage applied to the LED chips.

The LED package 14 according to the sixth embodiment is configured such that a plurality of LED chips are connected in parallel with each other and such that each resistor is connected in series with each of the plurality of LED chips. Thus, the battery voltage can be supplied from each of a plurality of units wherein each unit includes a single LED chip and a single resistor. The voltage required for the illumination of a single LED chip is well below the voltage of 13 V, so that the LED can be lit up even though the battery voltage varies (drops). Also, the voltage applied to the LED chip can be optimized by adjusting the resistance value of the resistor 16.

As described above, by employing the light-emitting module 110 according to the sixth embodiment, the voltage applied to the LED chips can be necessarily and sufficiently ensured even though the batter voltage fluctuates.

The present invention has been described by referring to each of the above-described embodiments. However, the present invention is not limited to the above-described embodiments only, and those resulting from any combination of them as appropriate or substitution are also within the scope of the present invention. Also, it is understood by those skilled in the art that various modifications such as changes in the order of combination or processings made as appropriate in each embodiment or changes in design may be added to the embodiments based on their knowledge and the embodiments added with such modifications are also within the scope of the present invention.

In each of the above-described automotive lamps, a lamp, where the reflector and the projection lens are combined, is used as an optical system. However, this should not be considered as limiting and, for example, a parabolic optical system using a parabolic reflector may be used instead.

What is claimed is:

1. An automotive lamp for use in vehicle, comprising:
a light-emitting module;
an optical element configured to irradiate light emitted by the light-emitting module toward a front area of the vehicle; and
a lamp housing configured to house the light-emitting module and the optical element,
the light-emitting module including:
a light-emitting diode (LED) package in which an LED is implemented; and
a resistor connected to the LED in series, the resistor being placed in a position subject to a change in temperature of the LED package,
wherein the resistor has a positive temperature coefficient, and
wherein the LED package and the resistor are placed in regions inside the lamp housing under an identical atmosphere.

2. An automotive lamp according to claim 1, wherein a volume resistivity of the resistor at 0° C. is 2×10⁻⁸ [Ω·m] or above.

3. An automotive lamp according to claim 1, wherein the temperature coefficient of the resistor in a range of 0° C. to 100° C. is 0.05[10⁻³/° C.] or above.

4. An automotive lamp according to claim 1, wherein, when the total electric power applied to all of LED chips in the light-emitting module is J [watt (W)], the total electric power applied to all of the resistors in the light-emitting module is 0.2×J [W] or above.

5. An automotive lamp according to claim 1, further comprising a heat-radiating member configured to support the LED package and radiate heat generated by the LED package,
wherein the resistor is mounted on the heat-radiating member.

6. An automotive lamp for use in vehicle, comprising:
a light-emitting module;
an optical element configured to irradiate light emitted by the light-emitting module toward a front are of the vehicle; and
a lamp housing configured to house the light-emitting module and the optical element,
a heat-radiating member configured to support the LED package and radiate heat generated by the LED package;
the light-emitting module including:
a light-emitting diode (LED) package in which an LED is implemented; and
a resistor connected to the LED in series, the resistor being placed in a position subject to a change in temperature of the LED package,
wherein the resistor has a positive temperature coefficient, and the resistor is mounted in a region, which is exposed outside the lamp housing, in the heat-radiating member.

7. An automotive lamp according to claim 2, wherein the temperature coefficient of the resistor in a range of 0° C. to 100° C. is 0.05[10⁻³/° C.] or above.

8. An automotive lamp according to claim 2, wherein, when the total electric power applied to all of LED chips in the light-emitting module is J [watt (W)], the total electric power applied to all of the resistors in the light-emitting module is 0.2×J [W] or above.

9. An automotive lamp according to claim 3, wherein, when the total electric power applied to all of LED chips in the light-emitting module is J [watt (W)], the total electric power applied to all of the resistors in the light-emitting module is 0.2×J [W] or above.

10. An automotive lamp according to claim 2, further comprising a heat-radiating member configured to support the LED package and radiate heat generated by the LED package,
wherein the resistor is mounted on the heat-radiating member.

11. An automotive lamp according to claim 3, further comprising a heat-radiating member configured to support the LED package and radiate heat generated by the LED package,
wherein the resistor is mounted on the heat-radiating member.

12. An automotive lamp according to claim 4, further comprising a heat-radiating member configured to support the LED package and radiate heat generated by the LED package,
wherein the resistor is mounted on the heat-radiating member.
